(19) United States
(12) Patent Application Publication
(10) Pub. No.: US 2025/0368189 A1
(43) Pub. Date: Dec. 4, 2025

(54) Autonomous Valet Parking System, and Infrastructure and Vehicle Thereof

(71) Applicants: Hyundai Motor Company, Seoul (KR); Kia Corporation, Seoul (KR)

(72) Inventor: Se Young Park, Hwaseong-Si (KR)

(21) Appl. No.: 18/965,786

(22) Filed: Dec. 2, 2024

(30) Foreign Application Priority Data
May 30, 2024 (KR) 10-2024-0070619

(51) Int. Cl. B60W 30/06; G06V 20/56; G06V 30/224

(52) U.S. Cl. CPC B60W 30/06; G06V 20/56; G06V 30/224; B60W 2420/403; B60W 2556/45

(57) ABSTRACT

Disclosed is an autonomous valet parking vehicle, including: a sensor unit configured to obtain image data associated with an environment around a vehicle; a controller configured to control at least one function of the vehicle; a communication apparatus configured to communicate with a server associated with autonomous valet parking; and a processor configured to receive, from the server, a movement request message comprising a control command for at least one of: acceleration, brake, or steering; control, based on the control command, the vehicle toward a service space; identify, based on the image data, a code marker corresponding to service selection information; and control, based on the code marker, an autonomous parking operation of the vehicle to park the vehicle in the service space.

### CROSS REFERENCE TO RELATED APPLICATION

This patent document claims the priority and benefits of Korean Patent Application No. 10-2024-0070619, filed on May 30, 2024, which is incorporated by reference in its entirety as part of the disclosure of this patent document.

### TECHNICAL FIELD

Various embodiments of the disclosed technology relate to a system for autonomous driving, and more specifically to a system which supports autonomous valet parking.

### BACKGROUND

An autonomous valet parking system may refer to a system which is capable of moving a vehicle to an empty parking space in a parking lot while a driver is not onboard or completing parking, after the driver stops the vehicle and gets off from the vehicle in a drop-off area.

In addition, when the driver calls for the vehicle, the autonomous valet parking system may autonomously move the parked vehicle to a pick-up area, and allow the driver to take over control of the vehicle in the pick-up area.

With a vehicle capable of the autonomous driving, the autonomous valet parking system may park a vehicle in an empty parking space.

When using various services in a parking lot which provides autonomous valet parking, it may be more convenient to make the vehicle move to a specified place than having a service provider (e.g., a human operator) locate and move the vehicle.

If the service provider simply checks only a parking position or vehicle appearance in the parking lot which provides the autonomous valet parking service, there may be a problem where a parking space becomes unavailable because another driver parks a vehicle in the parking space first, a preceding vehicle did not exit the corresponding parking space, or the target vehicle parks at another parking space due to a vehicle sensor fault, etc.

### SUMMARY

Therefore, various embodiments disclose a system capable of providing a smooth service through accurate matching between a vehicle and a service provider by using a code marker in the parking lot, which provides the autonomous valet parking, and a method for operating the same.

The technical problem to be achieved by the present disclosure is not limited to the above-mentioned technical problem, and other technical problems that are not mentioned will be clearly understood by ordinary-skilled persons in the art to which the present disclosure pertains from the following description.

According to one or more example embodiments of the present disclosure, a vehicle may include: a sensor configured to obtain image data associated with an environment around the vehicle; a controller configured to control at least one function of the vehicle; a communication apparatus configured to communicate with a server associated with autonomous valet parking; and a processor. The processor may be configured to: receive, from the server, a movement request message including a control command for at least one of: acceleration, brake, or steering; control, based on the control command, the vehicle toward a service space; identify, based on the image data, a code marker corresponding to service selection information; and control, based on the code marker, an autonomous parking operation of the vehicle to park the vehicle in the service space.

The processor may be further configured to: receive, from the server, available service information. The available service information may include information about at least one of a delivery service, a maintenance service, a car wash service, or a charging service; and transmit, to the server, the service selection information.

The processor may be further configured to: receive, from the server: service space position information corresponding to the service selection information, and marker image information corresponding to the service selection information.

The processor may be configured to identify the code marker by: identifying, based on the image data, the code marker that corresponds to the marker image information.

The image data may be obtained at a first time. The sensor may be mounted on a side of the vehicle. The processor may be configured to identify the code marker by: controlling the vehicle to perform forward parking or reverse parking at the service space; and identify, at a second time later than the first time, the code marker based on second image data that is obtained via a second sensor mounted in one of a front portion or a back portion of the vehicle.

The processor may be further configured to: transmit, based on identifying the code marker at the second time, a parking complete notification message to the server.

The processor may be further configured to: receive, from the server, a service complete notification message, a vehicle exit request message, and re-parking position information.

The processor may be further configured to: transmits, to the server and based on the re-parking position information, a re-parking complete notification message after the vehicle moves to a re-parking position.

According to one or more example embodiments of the present disclosure, a computing device may include: data storage configured to store code marker information; a communication apparatus configured to communicate with a vehicle; and a processor configured to: transmit, to the vehicle, a movement request message including a control command for at least one of: acceleration, brake, or steering; identify, based on image data associated with an environment around the vehicle, a code marker corresponding to service selection information; and cause, based on the code marker, the vehicle to perform an autonomous parking operation to park the vehicle in a service space.

The processor may be further configured to: transmit, to the vehicle, available service information. The available service information may include information about at least one of a delivery service, a maintenance service, a car wash service, or a charging service; and receive, from the vehicle, the service selection information. The computing device may include at least one server associated with autonomous valet parking.

The processor may be further configured to: transmit, to a service provider, service reservation information and vehicle information.

The image data may be captured via a sensor mounted on a side of the vehicle. The processor may be configured to identify the code marker based on stored marker image information.

The processor may be configured to cause the vehicle to perform the autonomous parking operation to park the vehicle in the service space by: transmitting, to the vehicle, a message requesting forward parking or reverse parking at the service space; and identify, at a time later than the code marker is identified based on the image data, the code marker based on second image data that is obtained via a second sensor mounted in one of a front portion or a rear portion of the vehicle.

The processor may be further configured to: receive, from a service provider, a service complete notification message; and transmit, to the vehicle, a service complete notification message, a vehicle exit request message, and re-parking position information.

According to one or more example embodiments of the present disclosure, a method performed by an apparatus of a vehicle may include receiving, from a server associated with autonomous valet parking, available service information; transmitting, to the server, service selection information; receiving, from the server: a movement request message including a control command for at least one of: acceleration, brake, or steering, and marker image information corresponding to the service selection information; controlling, based on the control command, the vehicle toward a service space; identifying, based on image information associated with an environment around the vehicle, a code marker corresponding to the marker image information; and controlling, based on the code marker, an autonomous parking operation of the vehicle to park the vehicle in the service space.

The image information associated with the environment around the vehicle may include first image data obtained via a first sensor mounted on a side of the vehicle.

Identifying the code marker may include: causing the vehicle to perform forward parking or reverse parking at the service space; and identifying the code marker based on second image data obtained via a second sensor mounted in one of a front portion or a rear portion of the vehicle.

The method may further include: transmitting, based on identifying the code marker using the second image data, a parking complete notification message to the server.

The method may further include: receiving, from the server, a service complete notification message, a vehicle exit request message, and re-parking position information.

The method may further include: transmitting, to the server and based on the re-parking position information, a re-parking complete notification message after the vehicle moves to a re-parking position.

### BRIEF DESCRIPTION OF THE DRAWINGS

FIG. 1 shows an autonomous valet parking system according to an embodiment of the present disclosure.

FIG. 2 is a block diagram of a vehicle and an autonomous valet parking server according to various embodiments of the present disclosure.

FIG. 3 is a conceptual diagram for describing an autonomous valet parking system and a method for operating the same according to an embodiment of the present disclosure.

FIG. 4 is a view illustrating an example of installing a marker in a parking lot.

FIG. 5 is a view illustrating examples of a unique marker and an anonymous marker.

FIG. 6 is a view illustrating examples of signs, words provided on a ground, or a symbol, a guidance board, or an advertisement board which may be seen in a parking lot.

FIG. 7 is a view illustrating a system configured to generate a digital map which includes a unique sign of a parking lot as an anonymous marker.

FIG. 8 is a flowchart illustrating a method for generating a digital map which includes a unique sign of a parking lot as an anonymous marker.

FIG. 9 is an example configuration of a digital map configured with five layers.

FIG. 10 is an example of recognizing position information of a vehicle by using a unique marker and an anonymous marker together.

FIG. 11 is an example illustrating a case of which a sign is changed.

FIGS. 12, 13, and 14 are examples illustrating a case in which a code marker is provided in a service-dedicated space.

FIG. 15 is a view for describing a method of autonomous valet parking using a code marker when providing a service in a parking lot.

### DETAILED DESCRIPTION

Hereinafter, embodiments of the present disclosure will be described in further detail with reference to the accompanying drawings.

The configuration and advantages of the present disclosure will be more apparent from the following detailed description. Wherever possible, the same reference numerals will be used throughout the drawings to refer to the same elements even if shown in another drawing. It will be paid attention that detailed description of known arts will be omitted if it is determined that the arts can mislead the present disclosure.

Before describing the present disclosure in detail, terms being used in the present disclosure may be defined as below.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., communications with autonomous valet parking server, and identification of code markers, etc.) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., communications with autonomous valet parking server, and identification of code markers, etc.) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., communications with autonomous valet parking server, and identification of code markers, etc.) described herein.

Minimum risk maneuver (MRM) operation(s) may also be controlled, for example, based on one or more features (e.g., communications with autonomous valet parking server, and identification of code markers, etc.) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., communications with autonomous valet parking server, and identification of code markers, etc.) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., communications with autonomous valet parking server, and identification of code markers, etc.) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

The vehicle may be equipped with an Autonomous Driving System (ADS) and is a vehicle capable of autonomous driving. For example, by the ADS, the vehicle may perform at least one among steering, acceleration, deceleration, lane change, and stopping (or short stop) without a driver's manipulation. For example, the ADS may include at least one among Pedestrian Detection and Collision Mitigation System (PDCMS), Lane Change Decision Aid System (LCDAS), Land Departure Warning System (LDWS), Adaptive Cruise Control (ACC), Lane Keeping Assistance System (LKAS), Road Boundary Departure Prevention System (RBDPS), Curve Speed Warning System (CSWS), Forward Vehicle Collision Warning System (FVCWS), and Low Speed Following (LSF).

A driver may be a human being who uses a vehicle, and is provided with a service of an autonomous driving system.

The vehicle control authority is an authority to control at least one component of the vehicle and/or at least one function of the vehicle. At least one function of the vehicle may include, for example, at least one among steering, acceleration, deceleration (or braking), lane change, lane detection, lateral control, obstacle recognition and distance detection, powertrain control, safe area detection, engine on/off, power on/off, and vehicle lock/unlock. The listed functions of the vehicle are merely examples for helping understanding, and embodiments of the present disclosure are not limited thereto.

The vehicle may have a function of performing autonomous valet parking.

An autonomous valet parking service may monitor vehicles present in a parking facility, determine a guide route to move a vehicle to a target position in a parking space (e.g., a designated parking space), determine a permitted driving area, instruct autonomous driving of a vehicle by transmitting a control command to the vehicle, and transmit an emergency stop command in case of emergency so as to stop the vehicle.

The infrastructure may be a parking facility, and may be sensors disposed in the parking facility. In addition, the infrastructure may include a parking gate, and according to an embodiment, the infrastructure may be a concept which includes an autonomous valet parking server.

A target position (e.g., a target destination, a designated position) may refer to a parking space that is empty and available for parking. In addition, the target position may refer to an area in which the driver gets on the vehicle in a situation in which the vehicle exits the parking lot, that is, a pick-up area.

The guide route may refer to a route by which the vehicle passes so as to reach the target position. For example, in a situation in which parking is performed, it is a route from the drop-off area to an empty parking space. For example, the guide route may take the form of ‘going forward by 50 m’, ‘turning to the left at a corner’, and the like. A driving route may refer to a route along which the vehicle follows.

The permitted driving area may refer to an area in which driving is permitted in the parking lot, such as the driving route. The permitted driving area may be defined with a partition, parked vehicles, and parking lines.

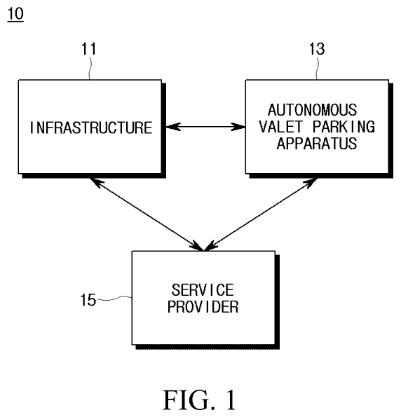

FIG. 1 shows an autonomous valet parking system according to an embodiment of the present disclosure.

Referring to FIG. 1, the autonomous valet parking system 10 may include an infrastructure 11, an autonomous valet parking apparatus 13, and a service provider 15.

The infrastructure 11 may mean a device or a system for operating, managing, and performing the autonomous valet parking system 10. For example, the infrastructure 11 may be a parking facility. According to embodiments, the infrastructure 11 may include sensors, a communication apparatus, an alarm, a display device, and a server configured to control the device and apparatus. In addition, the infrastructure 11 may include a parking gate, and an autonomous valet parking server configured to control a vehicle.

The autonomous valet parking apparatus 13 may mean a vehicle which performs the autonomous valet parking. According to embodiments, the autonomous valet device 13 may mean a component or a group of components included in a vehicle capable of performing the autonomous valet parking.

The service provider 15 may mean a terminal of an operator who provides a user with a service (for example, a delivery service of goods or food, etc., a maintenance service, a car wash service, a charging service etc.), a service providing device (for example, an unattended robot, an unattended device), or a service providing system.

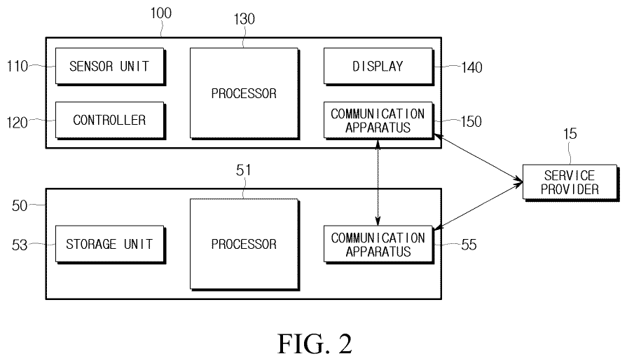

FIG. 2 is a block diagram of a vehicle and the autonomous valet parking server according to various embodiments of the present disclosure.

The configuration of the vehicle and the autonomous valet parking server illustrated in FIG. 2 is one embodiment, and each component may be configured as one chip, one component, or one electronic circuit, or a combination of chips, components, and/or electronic circuits. According to the embodiment, some of the components illustrated in FIG. 2 may be divided into a plurality of components and configured as different chips, different components, or different electronic circuits, and some components may be combined to form one chip, one component, or one electronic circuit. According to the embodiment, some of the components illustrated in FIG. 2 may be omitted or other components not illustrated may be added. At least some of the components of FIG. 2 will be described with reference to subsequent drawings.

Referring to FIG. 2, an autonomous valet parking server 50 may include a processor 51, a storage unit 53 (e.g., also referred to as storage or data storage), and a communication apparatus 53.

The storage unit 53 may store a digital map of a parking lot in which the autonomous valet parking is possible.

In addition, the storage unit 53 may statically or temporarily store all information necessary for the autonomous valet parking including information on vehicles parked in the parking lot, and components of the infrastructure. According to the embodiment, the information may be stored as information included in the digital map.

The storage unit 53 may store information on a code marker for each service. For example, if a type of a service is a delivery service of goods or food, etc., information on a code marker includes a sign which reminds delivery, if a type of a service is a maintenance service, information on a code marker includes a sign which reminds maintenance, if a type of a service is a car wash service, information on a code marker includes a sign which reminds car wash, and if a type of a service is a charging service, information on a code marker includes a sign which reminds charging.

The sign may be configured with an individual symbol, a logo, a mark, a character, and a figure, or a combination thereof.

Referring to FIG. 2, the vehicle 100 may include a sensor unit 110 (also referred to as a sensor), a controller 120, a processor 130, a display 140, and a communication apparatus 150.

According to various embodiments, the sensor unit 110 may sense a surrounding environment of the vehicle 100 using at least one sensor, and generate data related to the surrounding environment based on the sensed result. For example, the sensor unit 110 may obtain information on objects around the vehicle (for example, other vehicle, a person, an object, a curb, a guardrail, a lane, an obstacle) based on the sensed data obtained from at least one sensor. Information on the object around the vehicle may include, for example, at least one among a position of the object, a size of the object, a shape of the object, a distance to the object, and a relative speed to the object. As another example, the sensor unit 110 may measure a position of the vehicle 100 using at least one sensor. The sensor unit 110 may include, for example, at least one selected among a camera, a light detection and ranging (LIDAR) sensor, a radio detection and ranging (RADAR) sensor, an ultrasonic sensor, an infrared sensor, and a position measurement sensor. The listed sensors are merely examples for helping understanding, and the sensors included in the sensor unit 110 of the present disclosure are not limited thereto.

According to the embodiment, a camera may generate image data which includes an object positioned in front, at a rear and on a side of the vehicle 100, by capturing image around the vehicle. According to the embodiment, the lidar may generate information on an object positioned in front, on a rear side and/or on a side of the vehicle 100 using light (or laser). According to the embodiment, the radar may generate information on an object positioned in front, on a rear side and/or on a side of the vehicle 100 using electromagnetic waves (or radio waves). According to the embodiment, the ultrasonic sensor may generate information on an object positioned in front, on a rear side and/or on a side of the vehicle 100 using ultrasonic waves. According to the embodiment, the infrared sensor may generate information on an object positioned in front, on a rear side and/or on a side of the vehicle 100 using infrared rays.

According to the embodiment, the position measurement sensor may measure the current position of the vehicle 100. The position measurement sensor may include at least one among a Global Positioning System (GPS) sensor, a Differential Global Positioning System (DGPS) sensor and a Global Navigation Satellite System (GNSS) sensor. The position measurement sensor may generate position data of the vehicle based on a signal generated by at least one among a GPS sensor, DGPS sensor and GNSS sensor.

According to various embodiments, the controller 120 may control operation of at least one component of the vehicle 100 and/or at least one function of the vehicle according to the control of the processor 130. The at least one function may be, for example, at least one among a steering function, an acceleration function (or a longitudinal acceleration function), a deceleration function (or a longitudinal deceleration function, a brake function), a lane change function, a lane detection function, an obstacle recognition and a distance detection function, a lateral control function, a powertrain control function, a safety zone detection function, an engine on/off, a power on/off, and a vehicle lock/unlock function.

According to the embodiment, the controller 120 may control at least one component of the vehicle and/or at least one function of the vehicle for autonomous driving of the vehicle 100 according to the control of the processor 130. For example, for the autonomous driving, the controller 120 may control the operation of at least one function among a steering function, an acceleration function, a deceleration function, a lane change function, a lane detection function, a lateral control function, an obstacle recognition and distance detection function, a powertrain control function, and a safe zone detection function.

According to various embodiments, the display 140 may visually display information related to the vehicle 100. For example, the display 140 may provide various information related to the state of the vehicle 100 to the driver of the vehicle 100 under the control of the processor 130. The various information related to the state of the vehicle may include at least one among information representing whether various components included in the vehicle and/or at least one function of the vehicle are normally operated, and information representing the driving state of the vehicle. However, in case of performing the autonomous valet parking without the driver, the display 140 may be in an off-state in which information is not displayed.

According to various embodiments, the communication apparatus 150 may send or receive data with the infrastructure 11. The communication apparatus 150 may be referred to as a vehicle-to-infrastructure (V2I) communication. In addition, the communication apparatus 150 may send or receive data with the other vehicle. The communication may be referred to as a vehicle-to-vehicle (V2V) communication. In addition, the V2I communication and the V2V communication may be collectively referred to as a vehicle-to-everything (V2X) communication. According to embodiments, the communication apparatus 150 may receive data transmitted from the infrastructure 11 (for example, a target position, a guide route, or a command etc.), and process the received data and send the processed data to the processor 130. In addition, the communication apparatus 150 may transmit data generated by the vehicle 100 to the infrastructure 11. According to embodiments, the communication apparatus 150 may send or receive data with a terminal of the driver of the vehicle 100. The infrastructure 11 may include the autonomous valet parking server 50 configured to control the parking gate and the vehicle.

The communication apparatus 150 may receive or send data by using a wireless communication protocol or a wired communication protocol. Examples of a wireless communication protocol may include wireless LAN (WLAN), digital living network alliance (DLNA), wireless broadband (Wibro), world interoperability for microwave access (Wimax), global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), IEEE 802.16, long term evolution (LTE), long term evolution-advanced (LTE-A), wireless mobile broadband service (WMBS), Bluetooth, radio frequency identification (RFID), infrared data association (IrDA), Ultra-Wideband (UWB), Zigbee, near field communication (NFC), ultra sound communication (USC), visible light communication (VLC), Wi-Fi, and Wi-Fi Direct. In addition, examples of the wired communication protocol may include wired local area network (LAN), wired wide area network (WAN), power line communication (PLC), USB communication, Ethernet, serial communication, an optical/coaxial cable, and the like, but are not limited thereto, and any and all protocol which can provide an environment for communication with the other devices may be included.

According to various embodiments, the processor 130 may control the overall operation of the vehicle 100. According to the embodiment, the processor 130 may include an electrical control unit (ECU) capable of integrally controlling components in the vehicle 100. For example, the processor 130 may include a central processing unit (CPU) or a micro processing unit (MCU) capable of performing arithmetic processing.

The processor 130 may control the controller 120 based on the data received through the sensor unit 110 and the communication apparatus 150. According to embodiments, the processor 130 may generate a control signal for controlling the vehicle 100 according to the data received from the infrastructure 11, and send the generated control signal to the controller 120.

The processor 130 may mean a device capable of controlling the vehicle 100, and performing a series of operations or determinations for performing the autonomous valet parking. For example, the processor 130 may be a part of the autonomous valet parking apparatus 13 in which programs including instructions for performing the autonomous valet parking is executed.

As a part of the autonomous valet parking apparatus 13, the processor 130 may control the autonomous driving such that the vehicle 100 can be parked at a target position in the parking lot in cooperation with the infrastructure 11. The processor 130 may provide the controller 120 with a command so that the controller 120 can perform the autonomous driving.

The processor 130 may control the vehicle to be moved according to the guide route based on guide route information received from the infrastructure 11.

In the above-described FIG. 2, the controller 120 and the processor 130 have been described as each separate component, however, according to various embodiments, the controller 120 and the processor 130 may be integrated into one component.

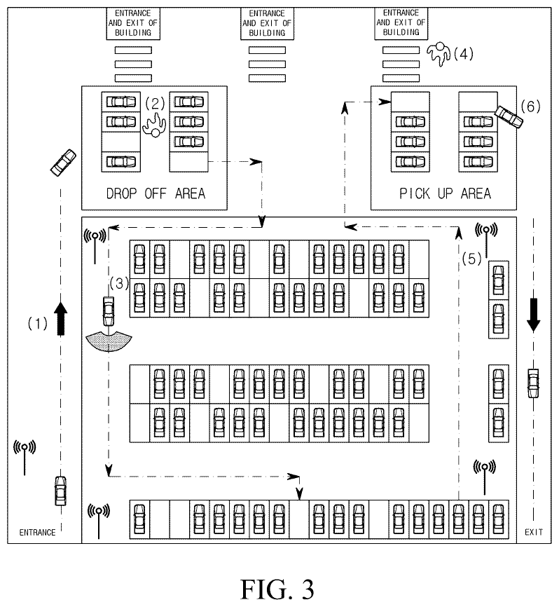

FIG. 3 is a conceptual diagram for describing the autonomous valet parking system and a method for operating the same according to an embodiment of the present disclosure.

Referring to FIG. 3, at position (1), the driver may drive the vehicle 100 to enter the parking lot, and move the vehicle to the drop-off area.

At position (2), the driver may park the vehicle in the drop-off area, get off the vehicle, and deliver the vehicle driving authority to the infrastructure.

At position (3), the infrastructure 11, or the autonomous valet parking server 50 included in the infrastructure 11 may search an empty parking space among a plurality of parking spaces present in the parking lot, and determine an appropriate parking space (a target position) for the vehicle to be parked. In addition, the infrastructure 11 may determine the guide route to the determined target position. When the target position and the guide route are determined, the vehicle 100 may travel according to the guide route autonomously or according to the control of the infrastructure 11, and perform the autonomous valet parking at the target position after reaching around the target position.

At position (4), the driver determines the vehicle to exit the parking lot and moves to the pick-up area.

At position (5), the infrastructure 11 or the autonomous valet parking server 50 included in the infrastructure 11 may determine a proper target position. For example, the proper target position may be an empty parking space among a plurality of parking spaces present in the pick-up area. In addition, the infrastructure 11 or the autonomous valet parking server 50 may determine the guide route to the determined target position. When the target position and the guide route are determined, the vehicle 100 travels along the guide route according to the control of the infrastructure 11 or autonomously, and performs the autonomous valet parking to park at the target position after reaching around the target position.

At position (6), the driver reaches the pick-up area, receives the vehicle driving authority for the vehicle 100 back from the infrastructure 11, and drives the vehicle to move to the exit of the parking lot.

As illustrated in FIG. 3, the vehicle 100 or the infrastructure 11 must have a map of the parking lot so as to travel along the guide route according to the control of the infrastructure 11 or autonomously, and must identify a position of the vehicle 100 in the map, and recognize whether the vehicle 11 travels accurately along the guide route. To this end, the vehicle 100 needs to capture the surroundings using the sensor with a camera, and to recognize its position based on the captured image.

To this end, according to the embodiment, a marker may be used. The marker may be a physical sign which allows to identify a unique identification (ID), which can be detected by the vehicle and is installed in the parking lot, so as to support the position verification of the vehicle 100.

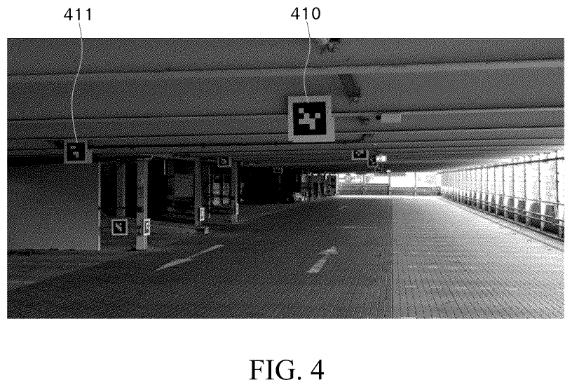

FIG. 4 is a view illustrating an example of installing the marker in the parking lot.

As illustrated in FIG. 4, it is possible to identify an accurate position in the parking lot by installing markers 410 and 411, which include unique IDs, at certain positions which can be detected by the vehicle 100, and allow the vehicle 100 to recognize the marker and to extract the unique ID, thereby being able to figure out a position corresponding to the unique ID in the digital map, and to identify a precise position in the parking lot.

In this case, the marker may have two kinds including a unique marker and an anonymous marker.

According to the embodiment, the unique marker may be a physical sign, which allows the vehicle to identify one among unique IDs from 1 to 250, and the unique ID from 1 to 250 may exist only one in number in the parking lot. Therefore, a vehicle which identifies the unique marker may figure out a position accurately in the digital map, which corresponds to the unique ID. In addition, the unique marker must be installed at a determined position according to laws or regulations of standards, for example, at an entrance for the vehicle to enter the parking lot from a drop-off area, or an exit for the vehicle to advance into a pick-up area from the parking lot. In this case, a unique ID, which is marked in the unique marker, may be set in advance.

According to the embodiment, a size of the unique marker may be determined according to regulations, and a display manner to display a unique ID in the unique marker may be determined in advance.

For the unique marker, a marker having a certain shape or a design drawn therein must be used and installed at a certain position (for example, an entrance and an exit). Therefore, it is difficult to install the unique marker freely, and as illustrated in FIG. 4, installation of a plurality of unique markers may make the parking lot be unsightly.

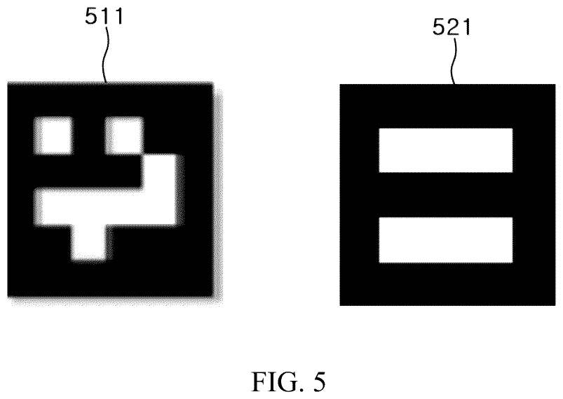

If using the anonymous marker, the above-described limitation of the unique marker may not be applied. According to the embodiment, the anonymous marker may have one ID from 251 to 255, and the complexity in displaying the corresponding ID may be different from that of the unique marker. According to the embodiment, displaying to show the ID in the anonymous marker may be simpler than that of the unique marker. Referring to FIG. 5, the unique marker 511 may be designed to be more complex than the anonymous marker 521 in expressing the ID.

In addition, the anonymous marker may be installed at a random position as needed. That is, unlike the unique marker, the anonymous marker may be installed randomly in consideration of a size and a structure of each parking lot. For example, in a big parking lot, a plurality of anonymous markers may be installed between unique markers to correct position errors of the vehicle. That is, using a first unique marker, it is possible to figure out an accurate current position of the vehicle, however, while the vehicle moves from a position of the first unique marker to a second unique marker, it is difficult to trace a position of the vehicle with an absolute accuracy of 50 centimeter. In such a case, using a plurality of anonymous markers, it is possible to raise the accuracy of the position of the vehicle. According to the embodiment, the anonymous marker may be used to assist the unique marker for accurately identifying the vehicle position. The vehicle may recognize the unique marker, and set position information of the vehicle through a position which corresponds to the unique marker. In addition, the vehicle may recognize the anonymous marker, and may correct the position information of the vehicle, using position information which corresponds to the anonymous marker.

However, as illustrated in FIG. 5, the unique marker 511 and the anonymous marker 521 must be coded to include ID information such as a QR code, and installed at a certain position. That is, the markers 511 and 521 must be manufactured and installed in a way to perform a unique function of a marker.

Based on such backgrounds, the present disclosure may use signs which are already installed in the parking lot, such as signs mandated to be installed in the parking lot, words provided on a ground, or a symbol, a guidance board, or an advertisement board, as markers.

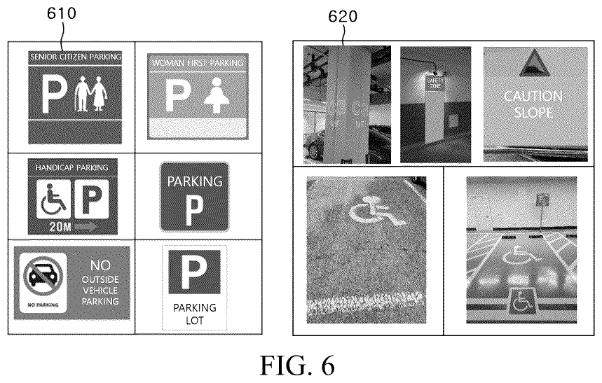

FIG. 6 is a view illustrating examples of signs, words provided on a ground, or a symbol, a guidance board, or an advertisement board which may be seen in a parking lot.

As illustrated in FIG. 6, various signs may be provided in the parking lot. In addition, each sign includes a different symbol and character, and is sufficiently distinguishable. As such, by obtaining and distinguishing signs which are already provided in the parking lot, it is possible to use them as the anonymous marker for positioning. In this case, in the signs which are set for positioning, IDs for the anonymous marker may be specified.

When using the signs already provided in the parking lot as the anonymous markers, it is necessary to determine characteristics to distinguish a first sign and a second sign, replacing the anonymous markers, from each other, and a position of the first sign in the digital map of the parking lot in advance, and to input the characteristics and the position in the digital map.

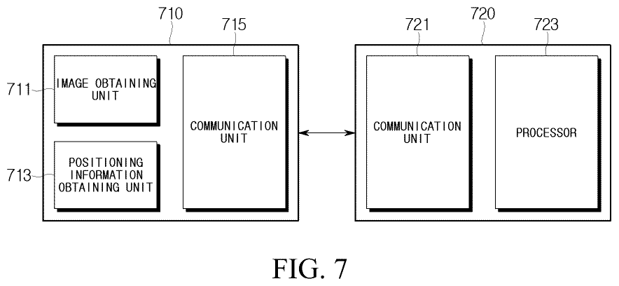

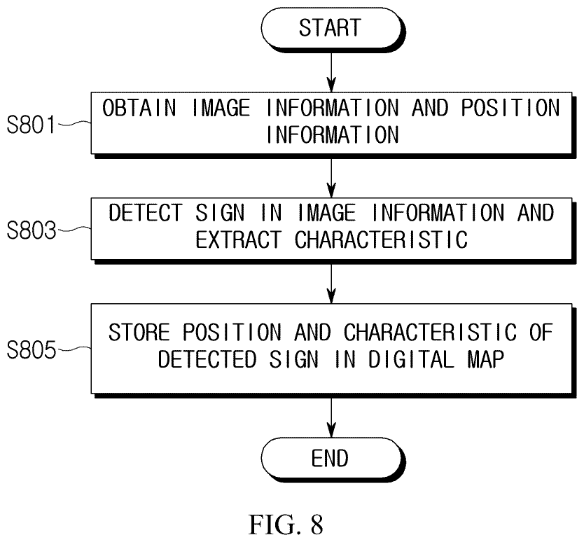

FIG. 7 is a view illustrating a system configured to generate a digital map which includes a unique sign of the parking lot as the anonymous marker, and FIG. 8 is a flowchart illustrating a method for generating the digital map which includes the unique sign of the parking lot as the anonymous marker.

Referring to FIGS. 7 and 8, a sign obtaining device 710 may include an image obtaining unit 711, a positioning information obtaining unit 713, and a communication unit 715, and a digital map generating device 720 may include a communication unit 721 and a processor 723.

According to the embodiment, the sign obtaining device 710 may be a vehicle, or a device which are temporarily provided in the vehicle and uses sensors attached to the vehicle. According to another embodiment, the sign obtaining device 710 may be an autonomous driving robot, which differs from the vehicle, or may be a smart device such as a smart mobile phone which is carried and moved by an operator.

The digital map generating device 720 may be the autonomous valet parking server, but may be a different device from the autonomous valet parking server according to another embodiment. According to another embodiment, the digital map generating device 720 may the autonomous valet parking server, or a computer program executable in a general computing device.

Referring to FIGS. 7 and 8, in an operation S801, the sign obtaining device 710 may obtain images inside the parking lot using the image obtaining unit 711, and at the same time, the positioning information obtaining unit 713 may obtain position information of positions at which each image is obtained. The image obtaining unit 711 may be a camera provided in the vehicle or a mobile phone, and the positioning information obtaining unit 713 may be a GPS system according to the embodiment, however, according to another embodiment, the positioning information obtaining unit 713 may be a separate positioning measuring device capable of accurately measuring a position at which a sign is provided using a facility provided for precise positioning.

The sign obtaining device 710 may send the obtained image information and the positioning information to the digital map generating device 720 through the communication unit 715.

In an operation S803, the digital map generating device 720 may detect signs from the image information received through the communication unit 721 and extract characteristics of each sign. According to the embodiment, the digital map generating device 720 may recognize a sign, a guidance board, words, or symbols shown in some of the image or in the entire image and detect signs.

The sign may include symbolic information such as the symbols for the disabled shown in the signs and on the ground, identification number marked on a wall or a column for identifying a parked surface, notices in various shapes and containing various contents, and the like.

The digital map generating device 720 may detect signs and then, extract characteristics corresponding to each sign. In this case, characteristics corresponding to each sign may include kinds of signs, components contained in the signs, colors included in the signs, and relative position information of the components of the sign from one another, but are not limited thereto. In this case, the components may include Korean characters, English characters, symbols, and the like.

According to the embodiment, the digital map generating device 720 may extract at least one among information and a position of an English character, information and a position of a Korean character, information and a position of a symbol, and a characteristic related to a position, each of which are included in each symbol.

When taking an example of a sign 610 in FIG. 6, the digital map generating device 720 may detect the sign 610 from the image, and may extract information and a position of a Korean character and information and a position of a symbol from the detected sign 610. The digital map generating device 720 may extract a characteristic that words “Elderly First Parking Section” are provided on an upper end of the sign 610. In addition, the digital map generating device 720 may extract a characteristic that a symbol ‘P’ and a symbol indicating the elderly is provided side by side on a center of the symbol 610 in a big size.

When taking an example of an identification number 620 of the parking surface from the image, the digital map generating device 720 may detect the identification number 620 of a parked surface from the image and obtain information and a position of an English character from the detected identification number 620. The digital map generating device 720 may extract the identification number of the parked surface, which are “C3” “MF”, from the image, and extract information that “C3” and “MF” are positioned vertically parallel to each other. In addition, a characteristic that “C3” is provided in a bigger size than that of “MF” may be extracted as well.

According to the embodiment, the above-described detection of the sign, and characteristics extraction of each sign may be performed based on the artificial intelligence.

Referring to FIGS. 7 and 8 again, in an operation S805, the digital map generating device 720 may correlate positions of signs detected in each image in the digital map and characteristics of the signs based on positioning information of each image obtained from the sign obtaining device 710 through the communication unit 721, and include them in the digital map. According to the embodiment, the digital map generating device 720 may indicate a symbol representing the detected sign at a position corresponding to the positioning information in the digital map. In addition, the digital map generating device 720 may include, in the digital map, the information of which a position corresponding to the positioning information in the digital map and characteristics of the detected signs are matched to each other.

According to another embodiment, position information based on the signs may be used additionally in the digital map. Parking lots in some implementations may already have unique markers or anonymous markers to inform position information installed therein, and the digital map may have the markers and position information correlated with each other stored therein. However, the vehicle may obtain position information of the vehicle based on the marker. However, due to the limiting conditions in installing the markers, markers may not be installed in every needed position inside the parking lot. Or, it may be difficult to identify precise positions required by the standards or laws and regulations with only the markers present at that time. In such a case, it is possible to replace the signs at the needed positions with the markers, or raise the accuracy of the position information by using the signs.

As described above, the marker information may be included in the digital map. For the autonomous valet parking system, the digital map must include not only concrete information of the actual static structural information of the parking lot for positioning and navigation etc., but also additional information for performing various missions such as enter and exit of the vehicle, rearrangement, and the like.

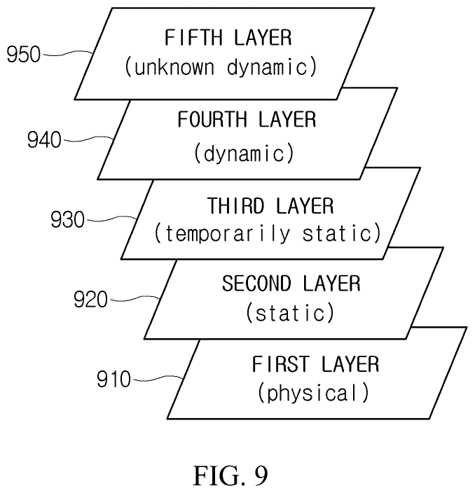

As such, in order to make the digital map include various information, the digital map of the present disclosure may be configured with five layers as illustrated in FIG. 9.

A first layer 910 of the digital map may include a physical three-dimensional space information. In addition, the first layer 910 includes information, through which whether the autonomous valet parking service can be provided for various vehicles can be checked. For example, in case of a parking lot constructed to have a plurality of stories, height information of each story may be included in the first layer 910, and the first layer 910 may provide information for determining whether the vehicle can be parked in the parking lot based on the height. In addition, the first layer may include size information of the parking space of the parking lot, and may provide information for determining whether the vehicle cannot be parked in a certain parking space and can be parked in another certain parking space.

A second layer 920 in the digital map may include static information. The second layer 920 may define a role of each space inside the parking lot. For example, the second layer 920 may set each area such as the drop-off area, the pick-up area, and the parking area, and a role of each area may have been defined. After the markers are installed, or if the signs are set to be used as the markers, the second layer 920 may include information of the corresponding maker or sign. For example, in case of the marker, information of an ID represented and positions of each marker may be included in the second layer 920. In case of the sign, characteristics from which the sign can be distinguished from the other, and position information of the corresponding sign may be included in the second layer 920.

A third layer 930 of the digital map may include temporarily static information. For example, the third layer 930 may include information representing whether the vehicle is parked in a certain parking space, therefore, the information may be used to check an available parking space.

A fourth layer 940 of the digital map may include dynamic information. For example, the fourth layer 940 may include information representing the maximum velocity and real-time movement of the vehicle performing enter and exit, and rearrangement. In case of a parking lot where enter and exit of a pedestrian is permitted, information of the pedestrian movement may be included in the fourth layer 940.

A fifth layer 950 of the digital map may include unknown dynamic information. For example, in a parking lot in which human intrusion is impossible in its design, if there is a movement of a pedestrian or an electric scooter, the corresponding movement may be included in the fifth layer 950 as unknown dynamic information. In addition, the fifth layer 950 may include an unknown object (a box, a timber, fallen from a vehicle) which is not previously installed but is temporarily detected due to a certain reason.

Unlike some maps being used for the purpose of providing a guide route for the autonomous driving vehicle, a digital map used in the parking lot may include the entire information in a parking lot. Such a digital map may be actively updated, and may be used by the autonomous valet parking server.

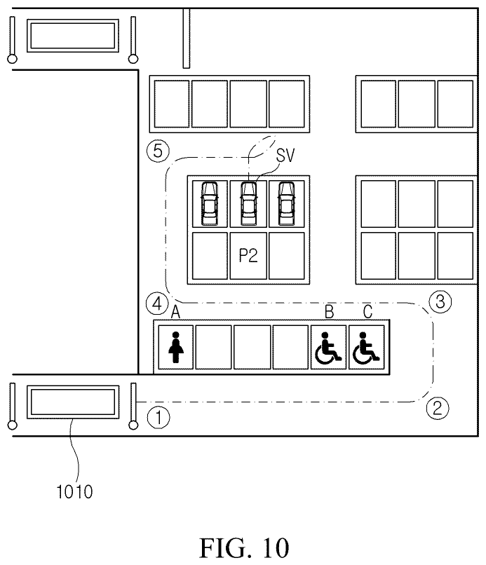

FIG. 10 is an example of recognizing position information of a vehicle by using the unique marker and the anonymous marker together.

Referring to FIG. 10, there may be a plurality of unique markers including five markers, which are marked as (1), (2), (3), (4), and (5) inside the parking lot. In addition, the sign obtaining device 710 and the digital map generating device 720 may detect signs A, B, and C in the parking lot, and may store the sign information in the digital map by correlating the signs to the position information.

If a unique marker or an anonymous marker exists nearby, or another sign is registered nearby when adding a sign in the digital map, the digital map generating device 720 may not add the corresponding sign. For example, a sign A in FIG. 8 is disposed at a position similar to the marker (4), and the sign A may not be necessary in obtaining the position information of the vehicle. Therefore, the digital map generating device 720 may not include the position information of the sign A in the digital map.

Similarly, the digital map generating device 720 may already have obtained position information of the sign B and have contained the position information thereof in the digital map. At this time, a sign C is disposed at a position similar to the sign B, therefore, the sign C may not be necessary in obtaining the position information of the vehicle. Accordingly, the digital map generating device 720 may not include position information of the sign C in the digital map.

Referring to FIG. 10, the vehicle may be parked at the drop-off area 1010 by the driver. Thereafter, the vehicle may be autonomously driven by the infrastructure 11 or the autonomous valet parking server 50 to proceed to a target position P2.

When the vehicle is autonomously driven by the control of the autonomous valet parking server 50, the autonomous valet parking server may provide the vehicle with the guide route and instruct the vehicle to autonomously travel by itself, or may provide the vehicle with a series of control commands based on the guide route.

The autonomous valet parking server 50 may detect a marker or a sign disposed at a position the vehicle passes by so as to figure out whether the vehicle travels along the guide route and may obtain the position information thereof. For example, upon recognizing the marker (1) while controlling the autonomous driving so as to park the vehicle, the autonomous valet parking server 50 may recognize that the vehicle performs autonomous driving after leaving the drop-off area. In addition, when the autonomous valet parking server 50 recognizes that the markers (2) and (3) are detected, the autonomous valet parking server 50 may recognize that the vehicle proceeds along the guide route. Likewise, the autonomous valet parking server 50 may recognize that the vehicle moves precisely along the guide route to the target position P2 as the sign B, and the markers (4) and (5) are recognized.

According to another embodiment, the sign information may be updated in real-time.

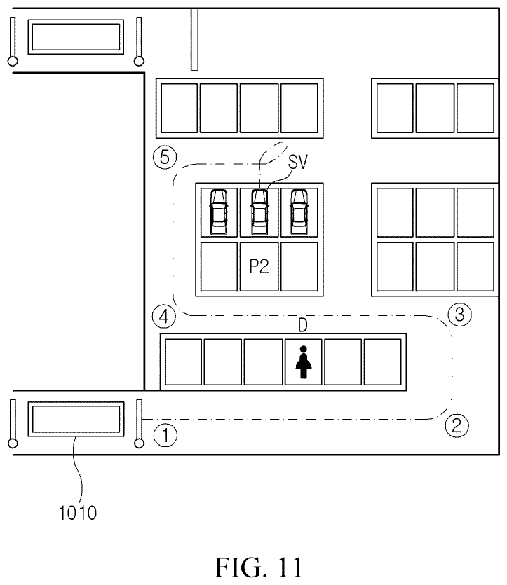

FIG. 11 is an example illustrating a case of which a sign is changed.

When comparing FIG. 10 and FIG. 11 with each other, the sign A, the sign B, and the sign C may be deleted and a sign D may be added. The autonomous driving vehicle may obtain images while traveling along the guide route for parking, and may transmit the images to the autonomous valet parking server 50. A server provided for the autonomous valet parking or, the digital map generating device 720 may detect that the existing signs A, B, and C disappeared and a new sign D appeared. The digital map generating device 720 may recognize that the sign A, the sign B, or the sign C is not detected from the image captured by the autonomous driving vehicle, and may determine that the signs are removed. According to another embodiment, when the corresponding signs are not detected from the images obtained from a plurality of vehicles, the digital map generating device 720 may determine that the signs are removed. As such, if determined that the signs, which are used as the markers for position detection, are removed, the digital map generating device 720 may remove the sign information and the position information which has been previously included in the digital map.

To the contrary, the digital map generating device 720 may recognize that the sign D is newly detected from the images captured by the autonomous driving vehicle, determine whether to use the new sign D as a marker for position detection, and if the new sign D is determined to be used as the marker for position detection, the sign D may be correlated with the characteristic thereof and the position information and may be stored in the digital map.

The digital map generating device 720 may update information of the markers and signs for position detection included in the existing digital map based on the image information obtained from the vehicle which travels for parking.

This may be applied in the same way for the markers. When a unique marker, an anonymous marker, or a sign for position detection included previously in the digital map is not detected based on the image information obtained from the vehicle traveling for parking, the digital map generating device 720 may update the digital map immediately by setting off an alarm, or reflecting that the corresponding marker or sign has disappeared.

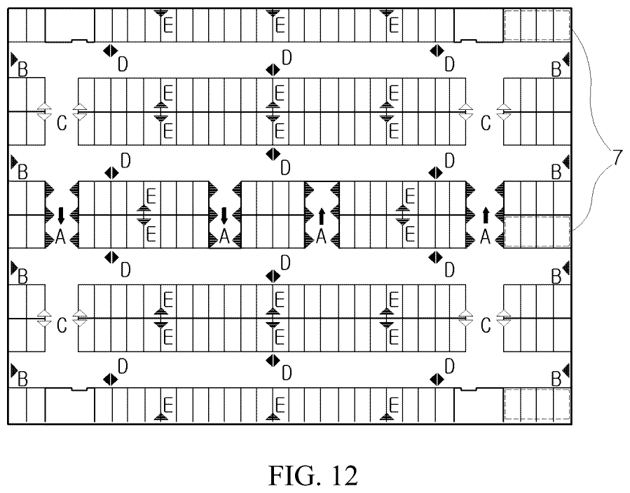

FIGS. 12 to 14 are examples illustrating a case in which a code marker is provided in a service-dedicated space.

Referring to FIG. 12, considering an area size of the parking lot and a purpose of a space, a service space 7 for providing a service may be set in some of the parking space and a code marker may be provided to the corresponding service space 7.

The code marker may be installed at a position which is easily recognizable in the service space 7. (for example, a ceiling, a wall, etc.) Though the code marker may be installed on the ground, but recognition of the code marker may be difficult because the code marker may be hidden by the vehicle and the like, and therefore, it may be advantageous to install the code marker at a position such as a ceiling or a wall etc. in which hiding due to the vehicle does not occur.

Referring to FIG. 12, the service spaces 7 are grouped in a certain space within the parking lot. A spot nearby the service space may mean a nearby passageway for moving to the corresponding service space.

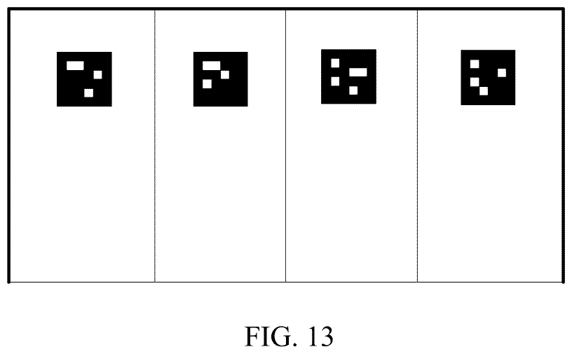

Referring to FIG. 13, the code marker may be one kind among the unique marker or the anonymous marker, or a combination thereof.

If the code marker is the unique marker, one among the unique IDs from 1 to 250 may be provided to each of the service spaces. The unique ID information may include the position information in the digital map, and service type information.

For example, in FIG. 13, the unique marker may be installed in each zone in the service space, one of the unique IDs from 1 to 250 may be provided as the unique marker per zone, and each unique ID information may include the position information in the digital map, and the service type information. The vehicle 100 or the autonomous valet parking server 50 may store code marker information corresponding to each unique ID information. The code marker information may include the position information in the digital map, and the service type information.

If the code marker is the anonymous marker, one ID among markers from 251 to 255 may be provided to each of the service spaces. The ID information may include the position information in the digital map, and the service type information.

For example, in FIG. 13, the anonymous marker may be installed in each zone within the service space, and the anonymous marker per zone may be one ID among markers from 251 to 255 provided, and the ID information may include the position information in the digital map, and the service type information.

The vehicle 100 or the anonymous valet parking server 50 may store the code marker information corresponding to the unique marker or the anonymous marker installed in the service space 7. The code marker information may include the position information in the digital map, and the service type information.

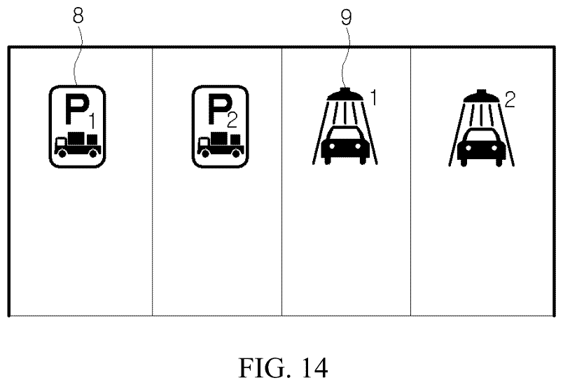

Referring to FIG. 14, the code marker may be an image marker which includes an image, a word, a symbol etc. related to the service. The image marker may be configured to be dualized through a color or a text such that the sensor unit 110 of the vehicle 100 or the driver can identify the marker. In case of a parking lot where the traveling by the driver is permitted or in which the service provider is a human depending on a parking environment, the image marker has an advantage of easy recognition compared to that of the code configuration of bit combination.

Each different numeral may be provided to the same image marker, and positions in the digital map and kinds of services may be provided to each image marker.

The vehicle 100 or the anonymous valet parking server 50 may store the code marker information corresponding to the image marker installed in the service space 7. The code marker information may include the position information in the digital map and service type information.

The code marker information may include additional information with respect to the requirement when parking the vehicle in the service space. The additional information is an example, and may include at least one among information requesting forward parking or reverse parking, and information requesting parking to be biased in (e.g., lean toward) a certain direction inside a parking line (e.g., within a parking space). For example, only the forward parking or the reverse parking may be requested in the service space, or parking to be biased in a certain direction among forward, rearward, left, and right directions inside the parking line may be requested.

The vehicle 100 may recognize the code marker, and then, may perform the autonomous parking based on the additional information included in the code marker.

As illustrated in FIG. 14, from the left side, an image marker 8 installed in the first zone of the service space is a marker related to a delivery service, and an image of a vehicle reminding the delivery and a numeral 1 for distinguishing the marker from a similar image marker are provided. The code marker information with respect to the corresponding image marker may include the position information in the digital map (for example, GPS coordinate in the digital map, zone number, etc.) and the service type information (for example, delivery service).

As illustrated in FIG. 14, from the left side, the image marker installed in the third zone of the service space is a marker related to a car wash service, and an image of water flow reminding car wash and a numeral 1 for distinguishing the marker from a similar image marker are provided. The code marker information with respect to the corresponding image marker may include the position information in the digital map (for example, GPS coordinate in the digital map, zone number, etc.) and the service type information (for example, delivery service).

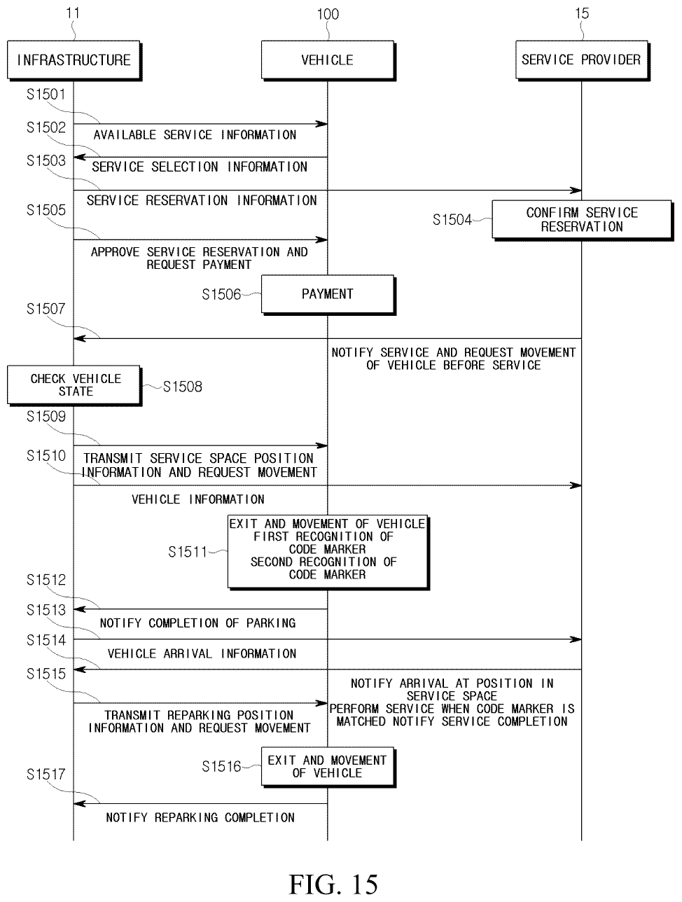

FIG. 15 is a view for describing a method of the autonomous valet parking using the code marker when providing a service in the parking lot.

Referring to FIG. 15, in an operation S1501, the infrastructure 11 may transmit information on an available service to the vehicle 100 which enters the parking lot, or to the driver's terminal (not illustrated). The information on an available service is an example, and may include information of a delivery service for goods or food, a maintenance service, a car wash service, a charging service etc. The infrastructure 11 may be a parking facility, and may be the sensors disposed in the parking facility. In addition, the infrastructure 11 may include a parking gate, and the infrastructure may be a concept which includes an autonomous valet parking server 50.

As an example, the infrastructure 11 may transmit the information on an available service and the additional information to the vehicle 100 which enters the parking lot, or to the driver's terminal (not illustrated). The information on an available service is an example, and may include a reservation state per service, and information of a time required per service.

In an operation S1502, the vehicle 100 or the driver's terminal (not illustrated) may transmit service selection information to the infrastructure 11. The service selection information is an example, and may include service type information, desired time information, and information with respect to the driver's agreement on the vehicle control (e.g., starting of the vehicle, traveling, door lock/unlock).

In an operation S1503, when the infrastructure receives the service selection information from the vehicle 100 or the driver's terminal (not illustrated), the infrastructure 11 may transmit the service reservation information and the vehicle information of the vehicle 100 to the service provider 15. The service reservation information is an example, and may include the service type information, and the desired time information.

In an operation S1504, the service provider 15 may transmit a confirmation message as to whether a service can be provided to the infrastructure 11.

In an operation S1505, if the service provider 15 can provide the service, the infrastructure 11 may approve the service reservation request of the vehicle 100 or the driver's terminal (not illustrated), and may transmit a payment request message to the vehicle 100 or the driver's terminal (not illustrated).

In an operation S1506, if the payment of the vehicle 100 or the driver's terminal (not illustrated) is completed, the infrastructure 11 may transmit a settlement complete notification message to the service provider 15.

In an operation S1507, the service provider 15 may transmit a service notification message to the infrastructure 11 before the service reservation time (e.g., 30 minutes before). The service provider 15 may transmit a message requesting the vehicle to move before the service reservation time (e.g., 10 minutes before).

In an operation S1508, the infrastructure 11 may determine a vehicle state as to whether the vehicle can drive etc. based on the vehicle information received from the vehicle 100.

In an operation S1509, when there is no abnormality, the infrastructure 11 may transmit marker image information corresponding to digital map information, route information, service space position information, and service selection information to the vehicle 100. At this time, the infrastructure 11 may transmit a movement request message to request movement to the position of the service space to the vehicle. The movement request message may include at least one control command among acceleration, brake, and steering.

When the vehicle 100 starts to move, the infrastructure 11 may transmit back and forth information of the vehicle movement (e.g., service ongoing stage information, vehicle position information). The marker image information is an example, and may include images, words, and symbols.

In an operation S1510, the infrastructure 11 may transmit vehicle information (e.g., model, color, license plate number) to the service provider 15.

In an operation S1511, after the vehicle 100 moves around the service space based on the movement request message including at least one control command among acceleration, brake, and steering, the vehicle 100 may recognize a code marker corresponding to the service selection information from the image data around the vehicle 100 (e.g., the image data associated with an environment around the vehicle 100). As an example, the vehicle 100 may recognize a unique marker from the captured image data while moving around the service space, and may set the position information of the vehicle 100 as the position corresponding to the unique marker. As an example, the vehicle 100 may recognize an anonymous marker from the captured image data while moving around the service space, and may correct the position information of the vehicle by using the position information corresponding to the anonymous marker.

The vehicle moves around the service space based on the movement request message including at least one control command among acceleration, brake, and steering, digital map information, route information, and service space position information, and generates first image data through a camera installed on the vehicle 100 (e.g., on a side of the vehicle 100). As a primary perception process, the vehicle 100 may recognize a code marker from the first image data captured on a side of the vehicle 100 based on the marker image information received from the infrastructure 11, using a prestored algorithm.

When the code marker is recognized from the first image data, the vehicle 100 may perform forward parking or reverse parking in a zone within the service space, and may generate second image data through a camera installed in front or at a rear of the vehicle 100. As a secondary perception process, the vehicle 100 may re-recognize the code marker from the second image data captured in front or at a rear of the vehicle 100 based on the marker image information received from the infrastructure 11, using the prestored algorithm.

If the code marker is not re-recognized, the vehicle 100 may move such that side capturing is possible, and may reperform the primary perception process. While moving to make side capturing possible, if interruption is expected due to movement of nearby vehicles, the vehicle 100 may generate a route for circulating around the spot and reperform the primary perception process.

In an operation S1512, when the code marker is re-recognized from the second image data, the vehicle 100 may transmit a parking complete notification message to the infrastructure 11.

As an example, from a time point when the vehicle 100 recognizes the code marker, the vehicle 100, not the infrastructure 11, may have the vehicle control authority according to the code marker translation result. As an example, if the infrastructure 11 controls movement of the vehicle 100, which is being different from the code marker recognition result, the code marker translation result may precede.

In an operation S1513, if the infrastructure 11 receives the parking complete notification message from the vehicle 100, the infrastructure 11 may transmit vehicle arrival information to the service provider 15.

In an operation S1514, the service provider 15 arrives in the service space and transmits service space arrival notification message to the infrastructure 11. The service provider 15 may determine whether the vehicle corresponds to the service target based on the code marker positioned at the service space and the vehicle information received from the infrastructure.

If it is determined that the vehicle is the service target, the service provider 15 may perform the service and transmit the service complete notification message to the infrastructure 11.

If the vehicle is not the service target, the service provider 15 may transmit an examination request message to the infrastructure 11.

In an operation S1515, when the infrastructure 11 receives the service complete notification message from the service provider 15, the infrastructure 11 may determine the vehicle state as to whether the vehicle can drive etc. based on the vehicle information received from the vehicle 100. When there is no abnormality in the vehicle state, the infrastructure 11 may transmit the service complete notification message, a vehicle exit request message, and re-parking position information to the vehicle 100 or the driver's terminal (not illustrated).

The infrastructure 11 may transmit back and forth information of the vehicle movement (e.g., information regarding whether the service is completed, vehicle position information).

In operations S1516 and S1517, the vehicle 100 may move to a re-parking position based on re-parking position information, and transmit a re-parking complete notification message to the infrastructure 11 or the driver's terminal (not illustrated).

As an example, the operation S1511 may be performed by the infrastructure 11. The infrastructure 11 may recognize the code marker corresponding to the service selection information from the image data around the vehicle received from the vehicle, which has moved to the position of the service space.

As the primary perception process, the infrastructure 11 may recognize the code marker from the first image data captured on a side of the vehicle 100 based on the marker image information, using the prestored algorithm.

When the code marker is recognized from the first image data, the infrastructure 11 may transmit a message requesting forward parking or reverse parking at the position of the service space to the vehicle 100. When the infrastructure 11 receives the complete notification message of forward parking or reverse parking from the vehicle 100, the infrastructure 11 may re-recognize the code marker from the second image data captured in front or at a rear of the vehicle 100 based on the marker image information, using the prestored algorithm, as the secondary perception process.

As above-described, according to the present disclosure, through the primary and secondary code marker perception processes, it is possible to match the vehicle with the service provider precisely and rapidly using the code marker when providing services in the parking lot which provides the autonomous valet parking, thereby the services can be provided smoothly.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

When the embodiments are implemented in program code or code segments, it should be appreciated that a code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc. Additionally, in some aspects, the steps and/or actions of a method or algorithm can reside as one or any combination or set of codes and/or instructions on a machine readable medium and/or computer readable medium, which can be incorporated into a computer program product.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

One embodiment is an autonomous valet parking vehicle, including: a sensor unit configured to obtain image data around a vehicle using at least one sensor; a controller configured to control at least one function of a vehicle; a communication apparatus configured to communicate with an autonomous valet parking server; and a processor configured to control operation of a vehicle, and the processor may recognize a code marker corresponding to service selection information from the image data around the vehicle after the vehicle moves near a service space based on a movement request message comprising at least one control command among acceleration, brake, and steering received from the autonomous valet parking server, and may perform parking at a position in a service space.

The processor may receive available service information from the autonomous valet parking server, and transmit the service selection information to the autonomous valet parking server.

The processor may receive service space position information and marker image information corresponding to the service selection information from the autonomous valet parking server.

The processor may recognize the code marker corresponding to the marker image information from first image data captured on a side of the vehicle.

When the code marker is recognized, the processor may perform forward parking or reverse parking at the position in the service space, and re-recognize the code marker from second image data captured in front or at a rear of the vehicle.

When the code marker is re-recognized, the processor may transmit a parking complete notification message to the autonomous valet parking server.

The processor may receive a service complete notification message, a vehicle exit request message, and re-parking position information from the autonomous valet parking server.

The processor may transmit a re-parking complete notification message to the autonomous valet parking server after the vehicle moves to a re-parking position based on the re-parking position information.

Another embodiment is an autonomous valet parking server, including: a storage unit configured to store code marker information; a communication apparatus configured to communicate with a vehicle; and a processor, and the processor may transmit a movement request message including at least one control command among acceleration, brake, and steering to the vehicle, and recognize a code marker corresponding to service selection information from image data around the vehicle which moved near a service space.

The processor may transmit available service information to the vehicle, and receive the service selection information from the vehicle.

The processor may transmit service reservation information and vehicle information of the vehicle to a service provider.

The processor may recognize the code marker based on first image data captured on a side of the vehicle and prestored marker image information.

When the code marker is recognized, the processor may transmit a message requesting forward parking or reverse parking at the position of the service space to the vehicle, and re-recognize the code marker from second image data captured in front or at a rear of the vehicle.

When the processor receives a service complete notification message from the service provider, the processor may transmit a service complete notification message, a vehicle exit request message, and re-parking position information to the vehicle.

Still another embodiment is a method for performing an autonomous valet parking of a vehicle, including: receiving, by the vehicle, available service information from an autonomous valet parking server; transmitting, by the vehicle, service selection information to the autonomous valet parking server; receiving, by the vehicle, a movement request message comprising at least one control command among acceleration, brake, and steering and marker image information corresponding to the service selection information from the autonomous valet parking server; recognizing, by the vehicle, the code marker corresponding to the marker image information from image data around the vehicle after the vehicle moves near a service space based on the movement request message; and performing, by the vehicle, parking at a position in a service space when the code marker is recognized.

The recognizing the code marker may include recognizing, by the vehicle, the code marker corresponding to the marker image information from first image data captured on a side of the vehicle.

The recognizing the code marker may further include: performing, by the vehicle, forward parking or reverse parking at the position in the service space when the code marker is recognized, and re-recognizing, by the vehicle, the code marker from second image data captured in front or at a rear of the vehicle.

The method may further include: transmitting, by the vehicle, a parking complete notification message to the autonomous valet parking server when the code marker is re-recognized.

The method may further include: receiving, by the vehicle, a service complete notification message, a vehicle exit request message, and re-parking position information from the autonomous valet parking server.

The method may further include: transmitting, by the vehicle, a re-parking complete notification message to the autonomous valet parking server after the vehicle moves to a re-parking position based on the re-parking position information.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Furthermore, as used in this application, the terms “component,” “module,” “system,” and the like are intended to refer to a computer-related entity, either hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

What is claimed is:

1. A vehicle comprising:
a sensor configured to obtain image data associated with an environment around the vehicle;
a controller configured to control at least one function of the vehicle;
a communication apparatus configured to communicate with a server associated with autonomous valet parking; and
a processor configured to:
receive, from the server, a movement request message comprising a control command for at least one of: acceleration, brake, or steering;
control, based on the control command, the vehicle toward a service space;
identify, based on the image data, a code marker corresponding to service selection information; and
control, based on the code marker, an autonomous parking operation of the vehicle to park the vehicle in the service space.

2. The vehicle of claim 1, wherein the processor is further configured to:
receive, from the server, available service information, wherein the available service information comprises information about at least one of a delivery service, a maintenance service, a car wash service, or a charging service; and
transmit, to the server, the service selection information.

3. The vehicle of claim 2, wherein the processor is further configured to:
receive, from the server:
service space position information corresponding to the service selection information, and
marker image information corresponding to the service selection information.

4. The vehicle of claim 3, wherein the processor is configured to identify the code marker by:
identifying, based on the image data, the code marker that corresponds to the marker image information.

5. The vehicle of claim 1, wherein the image data is obtained at a first time, wherein the sensor is mounted on a side of the vehicle, and wherein the processor is configured to identify the code marker by:
controlling the vehicle to perform forward parking or reverse parking at the service space; and
identify, at a second time later than the first time, the code marker based on second image data that is obtained via a second sensor mounted in one of a front portion or a back portion of the vehicle.

6. The vehicle of claim 5, wherein the processor is further configured to:
transmit, based on identifying the code marker at the second time, a parking complete notification message to the server.

7. The vehicle of claim 1, wherein the processor is further configured to:
receive, from the server, a service complete notification message, a vehicle exit request message, and re-parking position information.

8. The vehicle of claim 7, wherein the processor is further configured to:
transmits, to the server and based on the re-parking position information, a re-parking complete notification message after the vehicle moves to a re-parking position.

9. A computing device comprising:
data storage configured to store code marker information;
a communication apparatus configured to communicate with a vehicle; and
a processor configured to:
transmit, to the vehicle, a movement request message comprising a control command for at least one of: acceleration, brake, or steering;
identify, based on image data associated with an environment around the vehicle, a code marker corresponding to service selection information; and
cause, based on the code marker, the vehicle to perform an autonomous parking operation to park the vehicle in a service space.

10. The computing device of claim 9, wherein the processor is further configured to:
transmit, to the vehicle, available service information, wherein the available service information comprises information about at least one of a delivery service, a maintenance service, a car wash service, or a charging service; and
receive, from the vehicle, the service selection information, and
wherein the computing device comprises at least one server associated with autonomous valet parking.

11. The computing device of claim 9, wherein the processor is further configured to:
transmit, to a service provider, service reservation information and vehicle information.

12. The computing device of claim 9, wherein the image data is captured via a sensor mounted on a side of the vehicle, and
wherein the processor is configured to identify the code marker based on stored marker image information.

13. The computing device of claim 12, wherein the processor is configured to cause the vehicle to perform the autonomous parking operation to park the vehicle in the service space by:
transmitting, to the vehicle, a message requesting forward parking or reverse parking at the service space; and
identify, at a time later than the code marker is identified based on the image data, the code marker based on second image data that is obtained via a second sensor mounted in one of a front portion or a rear portion of the vehicle.

14. The computing device of claim 13, wherein the processor is further configured to:
receive, from a service provider, a service complete notification message; and
transmit, to the vehicle, a service complete notification message, a vehicle exit request message, and re-parking position information.

15. A method performed by an apparatus of a vehicle, the method comprising:
receiving, from a server associated with autonomous valet parking, available service information;
transmitting, to the server, service selection information;
receiving, from the server:
a movement request message comprising a control command for at least one of: acceleration, brake, or steering, and
marker image information corresponding to the service selection information;
controlling, based on the control command, the vehicle toward a service space;
identifying, based on image information associated with an environment around the vehicle, a code marker corresponding to the marker image information; and
controlling, based on the code marker, an autonomous parking operation of the vehicle to park the vehicle in the service space.

16. The method of claim 15, wherein the image information associated with the environment around the vehicle comprises first image data obtained via a first sensor mounted on a side of the vehicle.

17. The method of claim 16, wherein the identifying of the code marker comprises:
causing the vehicle to perform forward parking or reverse parking at the service space; and
identifying the code marker based on second image data obtained via a second sensor mounted in one of a front portion or a rear portion of the vehicle.

18. The method of claim 17, further comprising:
transmitting, based on identifying the code marker using the second image data, a parking complete notification message to the server.

19. The method of claim 15, further comprising:
receiving, from the server, a service complete notification message, a vehicle exit request message, and re-parking position information.

20. The method of claim 19, further comprising:
transmitting, to the server and based on the re-parking position information, a re-parking complete notification message after the vehicle moves to a re-parking position.
